(19) United States
(12) Patent Application Publication
(10) Pub. No.: US 2021/0334430 A1
(43) Pub. Date: Oct. 28, 2021

(54) METHOD TO ENGINEER DEPENDABILITY INTO ABANDONMENT/KICK-OFF PLUGS

(71) Applicant: Halliburton Energy Services, lnc., Houston, TX (US)

(72) Inventor: Siva Rama Krishna JANDHYALA, The Woodlands, TX (US)

(21) Appl. No.: 16/485,364

(22) PCT Filed: Nov. 6, 2018
(86) PCT No.: PCT/US18/59441

§ 371 Date: Aug. 12, 2019

(51) Int. Cl. G06F 30/20

(52) U.S. Cl. CPC G06F 30/20; E21B 33/12

(57) ABSTRACT

A system and method comprising utilizing numerical analysis to determine the dependability of plug formulations and locations in wells. The plugs are typically used for abandonment or kick-off purposes. The system and method rely on defining initial physical and material properties, generating a geometric model, and applying loads and boundary conditions to the model. The numerical analysis is preformed to determine stress or deformation for the components of the well, thus providing a basis for selecting a suitable well plug formulation and location.

### FIELD

The present disclosure relates generally to the field of geomechanical modeling, and more specifically, to the analysis of plug properties for the selection of plugs useful in abandonment and kick-off operations.

### BACKGROUND

Plug formulations are important for ensuring that a plug maintains long-term mechanical integrity when used for well abandonment and kick-off operations. Problems with plugs can result from excessive shrinkage or expansion of the plug material during curing, which causes debonding or cracks. Additionally, unwanted production from below the plug after abandonment can exert load on the plug, which can degrade its integrity. For example, the unwanted production can release CO₂, or other corrosive gases, which can cause mechanical damage to cement plugs. Additionally, pressure testing a casing after a plug is set can cause failure of plug material or the plug-casing bond.

Unfortunately, the oil and gas industry does not currently have any method or design tools to estimate a plug's dependability or aid in the selection of plug formulations. Accordingly, it would be beneficial to have a method encompassing a design tool that can predict lifetime failure rate of plugs to better formulate plugs for specific well conditions.

### BRIEF DESCRIPTION OF THE DRAWINGS

The drawings included with this application illustrate certain aspects of the embodiments described herein. However, the drawings should not be viewed as exclusive embodiments. The subject matter disclosed herein is capable of considerable modifications, alterations, combinations, and equivalents in form and function, as will be evident to those skilled in the art with the benefit of this disclosure.

FIG. 1 schematically illustrates a computer system capable of carrying out the method of this disclosure.

FIG. 2 is a flow diagram illustrating an embodiment of a method in accordance with this disclosure.

FIG. 3 is an illustration of an example well and initial conditions for the well for which the method of this disclosure was used for the Example.

FIG. 4 is an illustration of an example plug in the well of FIG. 3 and of the loads and conditions associated with the plug.

FIG. 5 is a schematic illustration of the geometric model generated for the analysis of the Example of this disclosure.

FIG. 6 shows a zoomed mesh view near the bottom right corner of the plug for the geometric model of the Example.

FIG. 7 shows the interface elements for the meshed geometry of FIG. 6.

FIG. 8 is a graph of the minimum remaining capacity versus years for the plug analyzed in the Example.

FIG. 9 is a pictorial description of shear remaining capacity on a 2D Mohr-Coulomb plot.

### DETAILED DESCRIPTION

The present disclosure may be understood more readily by reference to this detailed description, including the figures. For simplicity and clarity of illustration, where appropriate, reference numerals may be repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may have been exaggerated to better illustrate details and features of the present disclosure.

As used herein, the term “strain” or “deformation” means a measure of the extent to which a body of material is deformed and/or distorted when it is subjected to a stress-inducing force. “Stress-Inducing Force” refers to an action of at least one force, load and/or constraint on a body of material that tends to strain the body. Examples of the body's deformation or distortion can include, without limitation, changes in the body's length (e.g., linear strain), volume (e.g., bulk strain) and/or a lateral displacement between two substantially parallel planes of material within the body (e.g., shear strain).

“Stress” is a measure of inter-particle forces arising within a body of material resisting deformation and/or distortion, in response to a stress-inducing force applied to the body, as particles within the body of material work to resist separation, compression and/or sliding.

“Remaining capacity” for a material subjected to load is a measure of susceptibility of the material to fail. Mathematically, it is analogous to the stress in a material scaled by the strength of the material. If the stress is compressive (tension) in nature, the strength property of interest is compressive (tensile) strength.

“Dependability” for a plug would mean the ability of the plug to remain structurally integral for long term (eternity if the plug is for abandonment) and thus not cause unwanted flows through either the plug itself or the plug-casing or plug-rock interface.

“Wait on cement” or “WoC” refers to suspending operations while allowing cement slurries to solidify, harden and develop compressive strength. The WoC time ranges from a few hours to several days, depending on the difficulty and criticality of the cement job in question. WoC time allows cement to develop strength, and avert development of small cracks and other fluid pathways in the cement that might impair zonal isolation.

“Wait on Plug” or “WoP” refers to suspending operations while allowing the plug composition to solidify, harden and develop compressive strength.

In accordance with this disclosure, systems, methods for determining dependability, long-term structural integrity and/or remaining capacity of a well plug are described below. The well plugs may be used to seal off well bores in the case of abandonment or kick-off operations. The method evaluates the dependability, integrity and/or remaining capacity of plugs of various compositions and at various locations in the well; thus, enabling the selection of a plug that meets the conditions of stress and load in the well ensuring a viable plug and plug location is selected that will have long-term structural integrity under plug off conditions.

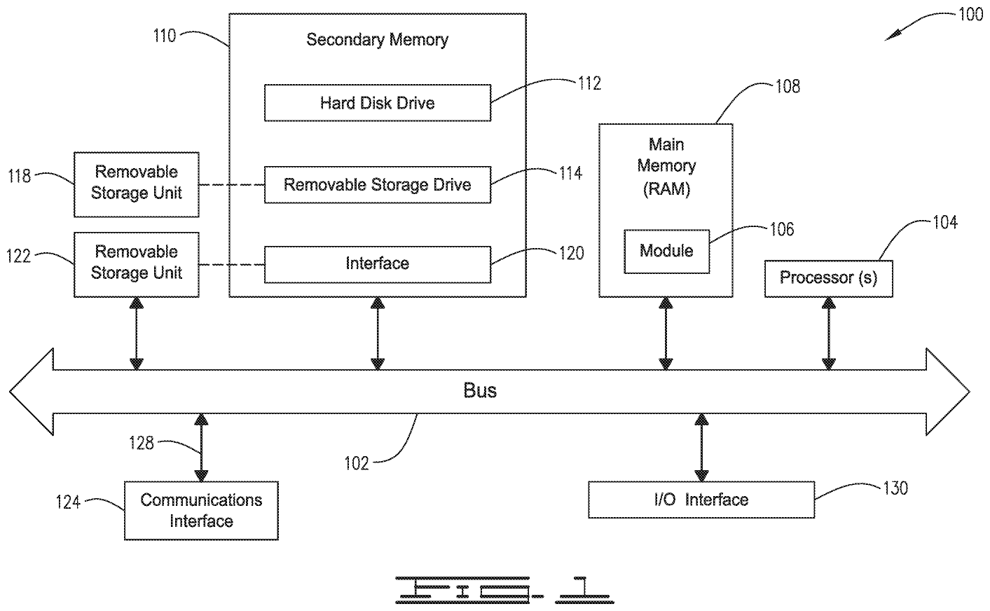

The method of the present disclosure can be carried out on a system such as the one illustrated in FIG. 1, which illustrates a computer system 100 capable of carrying out the functionality described herein. While this exemplary computer system 100 is described, it will be apparent to a person skilled in the relevant art how to implement the method of the present disclosure using other computer systems and/or computer architectures.

The example computer system 100 includes one or more processors, such as processor 104. The processor 104 is connected to a computer system internal communication bus 102. Computer system 100 also includes a main memory 108, preferably random access memory (RAM), and may also include a secondary memory 110. The secondary memory 110 may include, for example, one or more hard disk drives 112 and/or one or more removable storage drives 114, representing, floppy disk drive, a magnetic tape drive, an optical disk drive, etc. The removable storage drive 114 reads from and/or writes to a removable storage unit 118 in a well-known manner. Removable storage unit 118, represents a floppy disk, magnetic tape, optical disk, etc. which is read by and written to by removable storage drive 114. As will be appreciated, the removable storage unit 118 includes a computer usable storage medium having stored therein computer software and/or data.

In alternative embodiments, secondary memory 110 may include other similar means for allowing computer programs or other instructions to be loaded into computer system 100. Such means may include, for example, a removable storage unit 122 and an interface 120. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 122 and interfaces 120 which allow software and data to be transferred from the removable storage unit 122 to computer system 100. In general, computer system 100 is controlled and coordinated by operating system (OS) software, which performs tasks such as process scheduling, memory management, networking and I/O services.

There may also be a communications interface 124 connecting to the bus 102. Communications interface 124 allows software and data to be transferred between computer system 100 and external devices. Examples of communications interface 124 may include a modem, a network interface (such as an Ethernet card), a communications port, a Personal Computer Memory Card International Association (PCMCIA) slot and card, etc. Software and data transferred via communications interface 124 are in the form of signals 128 which may be electronic, electromagnetic, optical, or other signals capable of being received by communications interface 124. The computer system 100 communicates with other computing devices over a data network based on a special set of rules (i.e., a protocol). One of the common protocols is TCP/IP (Transmission Control Protocol/Internet Protocol) commonly used in the Internet. In general, the communications interface 124 manages the assembling of a data file into smaller packets that are transmitted over the data network or reassembles received packets into the original data file. In addition, the communications interface 124 handles the address part of each packet so that it gets to the right destination or intercepts packets destined for the computer system 100. In this disclosure, the terms “computer program medium” and “computer usable medium” are used to generally refer to media such as removable storage drive 114, and/or a hard disk installed in hard disk drive 112. These computer program products are means for providing software to computer system 100.

The computer system 100 may also include an input/output (I/O) interface 130, which provides the computer system 100 to access monitor, keyboard, mouse, printer, scanner, plotter, and alike.

Computer programs (also called computer control logic) are stored as application modules 106 in main memory 108 and/or secondary memory 110. Computer programs may also be received via communications interface 124. Such computer programs, when executed, enable the computer system 100 to perform the features of the present disclosure as discussed herein. In particular, the computer programs, when executed, enable the processor 104 to perform features of the present disclosure. Accordingly, such computer programs represent controllers of the computer system 100.

In an embodiment where the method of the present disclosure is implemented using software, the software may be stored in a computer program product and loaded into computer system 100 using removable storage drive 114, hard disk drive 112, or communications interface 124. The application module 106, when executed by the processor 104, causes the processor 104 to perform the functions of the present disclosure as described herein.

The main memory 108 may be loaded with one or more application modules 106 that can be executed by one or more processors 104 with or without a user input through the I/O interface 130 to achieve desired tasks. In operation, when at least one processor 104 executes one of the application modules 106, the results are computed and stored in the secondary memory 110 (i.e., hard disk drive 112).

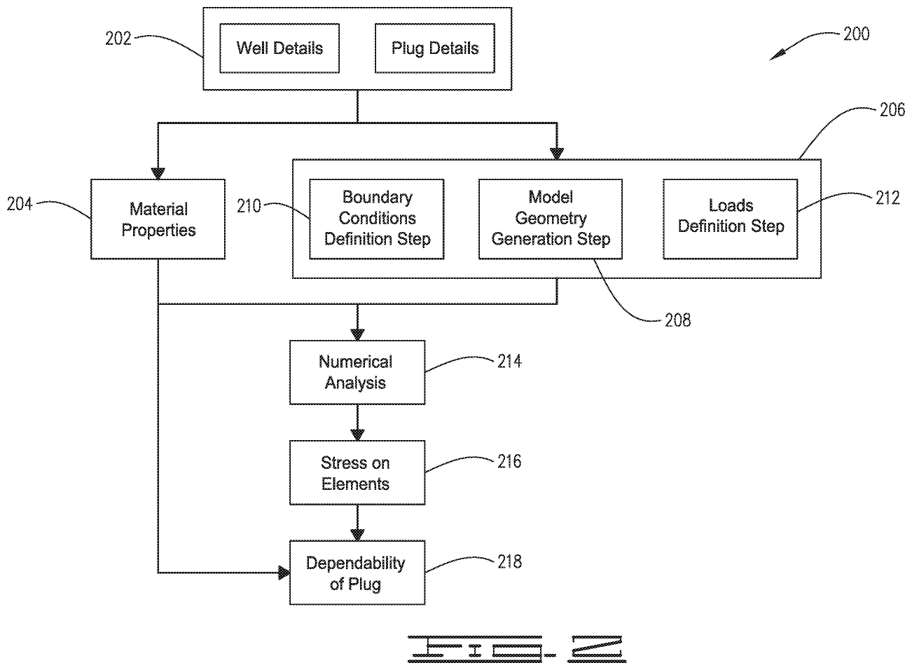

FIG. 2 presents a flow diagram illustrating a method 200, which exemplifies the process of this disclosure in accordance with one embodiment. The method 200 sets out steps that may be followed for the purpose of developing a numerically tractable, multi-scale geomechanical modeling framework suitable for computer simulation, such as one carried out on computer system 100 described above.

In accordance with method 200, the first step is to define initial physical properties 202 and material properties 204 for a geomechanical system. For the current process of analyzing well plugs, the geomechanical system includes a well, a plug and a well location for the plug. The well typically includes a wellbore casing and the surrounding geophysical structure; however, in some applications, the well can include an uncased wellbore and the surrounding geophysical structure.

The initial physical properties and material properties of the well will typically include data from the entire sequence of well construction and operation stages so as to inherit the correct stress state existing during the event of plugging the well. For the example, the sequence of well construction and operation stages can include drilling, followed by running casing, then cementing, WoC, pressure testing the cemented casing, and finally production. Generally, such data will reflect temperatures along the wellbore, pressure gradients, fluid characteristics, formation vertical stress gradients and similar considerations. The data can be obtained by methods known in the art such as well logging.

Similarly, the plug physical properties generally will include data on the plug construction and operation stages. For example, the sequence of plug construction and operation stages can include placing plug, followed by wait on plug (WoP), and then plug life. Generally, such data will reflect plug length, plug location, mud and spacer gradients, and similar considerations.

Material properties will typically be reflected by characterizations of the plug composition, casing composition, cement composition and formation(s) composition as reflected by standard modulus, such as Young's Modulus, Poisson's Ratio, coefficient of thermal expansion, coefficient of thermal conductivity, volumetric specific heat, cohesion and friction angle, shrinkage or expansion of cement. Casing composition and cement compositions will be known from the casing and cement operations.

Accordingly, well and plug details along with material properties form the inputs. As will be appreciated, since typically the method will be used to determine the composition of a suitable plug, often the plug properties will be selected based on an initial guess of a plug composition that could be suitable for the current well. Subsequent analyses can use secondary, tertiary, etc. guesses based on the results of the initial guess so as to iterate the plug properties until arriving at a plug composition where the stresses on plug are at a predetermined safe distance from the plug failure properties.

The initial physical properties 202 and material properties 204 for the geomechanical system are then used in modeling 206 to generate a geometric model in step 208 to which boundary conditions form boundary definitions step 210 and loads from loads definition step 212 are applied.

The purpose is to create a three-dimensional, map-based model from subsurface data. In some embodiments, this three-dimensional map-based model can be simplified for the numerical analysis step 214 by application of symmetry. Typically, the simplification is to a two-dimensional axi-symmetric model of the geomechanical system but in some cases is to a two-dimensional model of the geomechanical system. However, in most circumstances, a two-dimensional model will not be appropriate because plugs generally need to a have a provision to apply axial pressure due to gas generation, pressure test, etc.; hence, the axial direction shall need to be considered. Accordingly, typically two-dimensional axi-symmetric can be used or a more complete three-dimensional model.

The geophysical model can be created out of stacked set of meshes. The three-dimensional map or two-dimensional axi-symmetric map is created by stacking a series of two-dimensional representations generated at different depths by known techniques. Thus, the map can include data at various depths including porosity, permeability, temperature and pressure. The mesh nodes along different stacks are linked and will communicate mutually to maintain continuity of the material (and thus its properties) that is represented by the mesh.

It is typically desirable that none of the necessary geometry information related to the plug and well is to be missed during this translation into the geometric model. For example, if loads are expected to be applied on top and bottom edges of the plug, then the model geometry has to include the entire plug length. Similarly, because the stress neighborhood of plug is critical, the model geometry should include some overburden and subsurface of wellbore along with the entire plug.

While in some embodiments, the geometric model is generated for the entire well. More typically, generating the geometric model is restricted to a portion of the well, which is less than the entire length of the well but includes a plug portion of the well containing the plug, an overburden portion to the plug portion and a subsurface portion to the plug portion. The overburden portion is selected to sufficiently represent loads in the well above the plug to produce an accurate analysis, and likewise, the subsurface portion (below the plug) is selected to sufficiently represent loads in the well below the plug to produce an accurate analysis. The length of the overburden and subsurface sections are chosen in such a way that there are no boundary effects within the plug region. Additionally, locations in the well that experience critical loads have to be included.

As will be appreciated from the above, thermal and structural loads relating to the plug, and boundary conditions (defined in step 212) are applied to constrain the geometric model. Typically, the application of thermal and structural loads is based on well construction data, well operation data and plug operation data. However, in some embodiments where the construction and well operation data have minimal effect, the application can be of only the plug operation data.

Typically, the loads are applied to the model in such a way that the below considerations are followed.
Loading on the model geometry should be identical to that in actual well construction. This includes the sequence of loads, their magnitude and duration.
Symmetry and boundary considerations play a role in identifying the geometric parts on which loads are to be applied.
There should be radial stress continuity at all times across different wellbore materials.
A scaled down model geometry may generate synthetic loads to compensate for overburden effects. For example, in-situ stresses and pressures from overburden should be applied on the reduced model geometry using modified densities or modified fluid pressures.
By virtue of the numerical analysis approach performed, additional load events sometime need to be applied which do not exist in an actual well. For example, the stress state in the well has to be modified to accommodate displacement fluid and plug fluid, and only then should the plug be assembled to the well. This will ensure that there is radial stress continuity across all wellbore materials at all times.
In case of axial model geometry, the loads should be a function of depth.
Some of the loads may vary with time. For example, the formation pore pressure during production may change with time. Similarly, the (gas) pressure below the plug may increase with time due to accumulation. These possibilities can be incorporated into loads definition.

Generally, all the inputs needed to define the loads can come from the well operation steps and logs like production pressures, formation pore pressures vs. time, etc.

Boundary conditions definition step 210 describes the constraints to be applied to the model geometry. These constraints provide a unique solution to the numerical analysis. Constraints differ based on the well construction event. For example, in the case of the drilling stage, the bottom of the formation is to be supported and the far edge of the formation is to be constrained. The later resembles an assumption that the radially far field stresses in the formation are insensitive to near wellbore changes in temperature and pressure. Similarly, the value of temperature at wellbore wall will be circulating temperature and that at the far edge will be an undisturbed in-situ value. Further, the constraints or boundary conditions themselves will change with axial location due to variations with depth. False constraints should not be applied to the model, lest the predictions are unreliable.

After the application of loads and boundary conditions, a numerical analysis of the geometric model is created in step 214 to determine dependability of the plug. The numerical analysis determines one or more properties for elements of the geometric model based on loads experienced by the geomechanical system. As indicated in step 216, the properties can include at least one of stress or deformation for the elements. The elements represent portions of the geomechanical system. In some embodiments, the numerical analysis is only for a single time; however, more typically, the numerical analysis is created for a plurality of times such that the dependability determined by the numerical analysis is based on the properties for the elements as a function of time for the loads experienced by the geomechanical system.

For example, the numerical analysis can be a finite analysis application, as are known in the art. Finite element analysis are methods of solving problems—such as stress, structure, heat transfer and fluid flow analysis problems—wherein a large problem is subdivided into smaller, simpler parts that are called finite elements. The simple equations that model these finite elements are then assembled into a larger system of equations that models the entire problem.

In some embodiments, the method concludes with step 218, which is an analysis of the dependability of the plug resulting from the above steps. That is, plug stresses versus plug failure properties. However, generally the dependability of plugs for application in a well can be better analyzed by comparing different well locations or different plug formulations. That is, the above steps method may be iterated with adaptive modification in plug material properties until such a point that the stresses in plug are safely away from the failure stresses (properties) of the plug.

Thus, often the method will include repeating the above steps for one or more additional geomechanical systems, where each of the additional geomechanical systems is different from other geomechanical systems. Typically, the difference of the additional geomechanical systems includes changing at least one initial physical or material property of the plug or changing the well location for the plug. After obtaining the dependability for various well locations and/or plug formulations, the dependability determined for each geomechanical system are compared with each other. In some embodiments, comparing the dependability includes determining the remaining capacity for the plug of each geomechanical system at the end of a predetermined period of time and then determining which plug formulation and/or location has the best remaining capacity. Also, comparing the dependability can include determining and comparing the deformation of each plug and/or location for the geomechanical systems. Also, comparing the dependability can include determining and comparing the stress of each plug and/or location for the geomechanical systems. Based on such comparisons, a plug and well location for the plug is selected for use in the well.

The above method, its steps and systems incorporating the method can be better understood by the following example, which illustrates the process as carried out for a well.

### Example

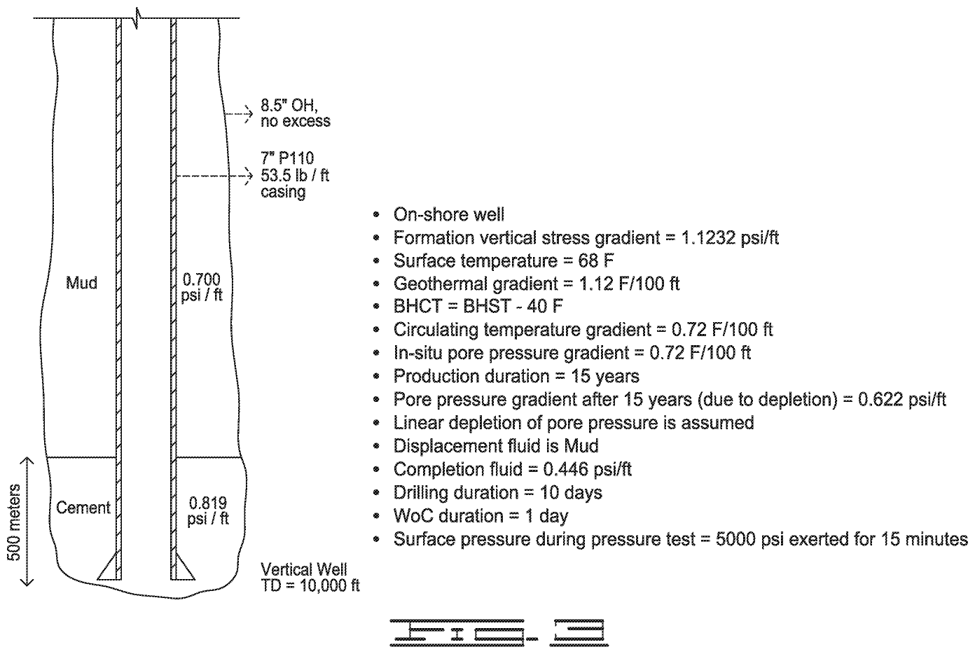

A well analysis was carried out in accordance with the above-described method. As a first step, an example well was synthesized for analysis as illustrated in FIG. 3. For the example, the sequence of well construction and operation stages included: drilling, followed by running casing, then cementing, WoC, pressure testing the cemented casing, and finally production. For this example, the entire sequence of stages was utilized for the model in order to inherit the correct stress state existing during the event of plugging the well.

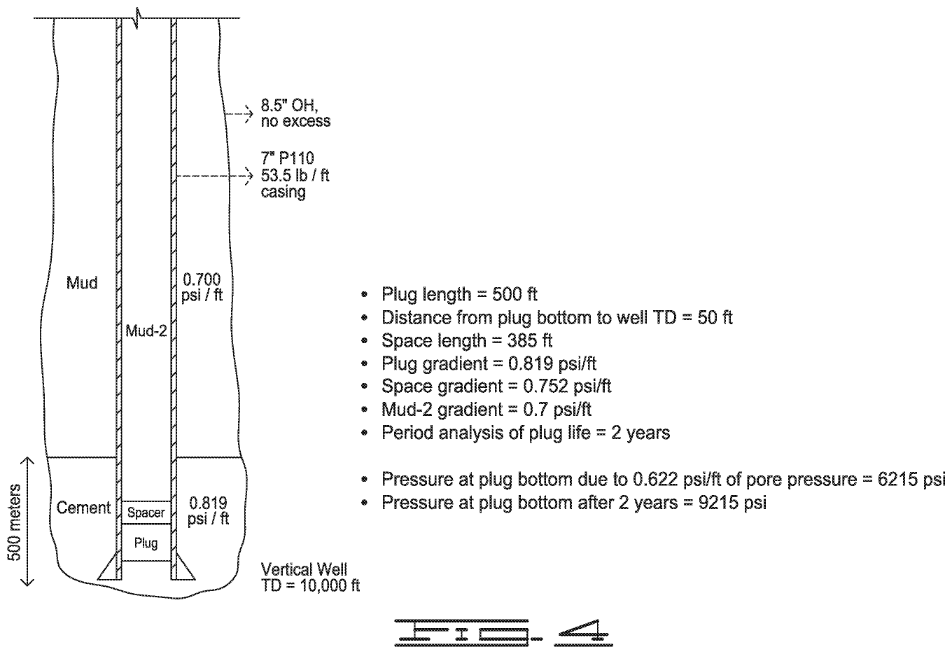

An example plug and its loads were synthesized for the analysis in accordance with the details shown in FIG. 4. The sequence of plug construction and operation stages includes placing plug, followed by wait on plug (WoP), and then plug life. During plug life, pressure buildup may occur at the plug bottom.

The pressure at the bottom of the plug during wait on plug (WoP) was assumed to be similar to the pore pressure of the formation just before abandonment/kick-off. This resulted in a calculated value of 6215 psi. To simulate the integrity of the plug, a hypothetical pressure buildup of 3000 psi was assumed to occur at the bottom of the plug. This buildup was assumed to have occurred linearly through a period of two years. In reality, pressure buildup can occur due to various reasons like gas flow, etc.

The next step in the analysis was geometry or model generation. The numerical analysis method which was used for this example was finite element environment to perform thermo-structural analysis using the well details and plug details defined above. A two-dimensional cross section geometry was not appropriate because typically plugs need to have a provision to apply axial pressures due to gas generation pressure test of the casing, etc. Hence, the axial direction should exist in geometry or model creation. Due to the symmetry, it was sufficient to analyze a two dimensional axi-symmetric geometry of the well. A full-scale three-dimensional geometry was not needed; however, the method could be performed using three-dimensional geometry if, for example, eccentricity of the casing had to be considered.

The size of the geometric model was configured such that it captured the critical locations to be analyzed and yet not be prohibitively time taking to analyze. Based on the example, well and plug details and the need to capture critical locations, the axi-symmetric model included the entire 500 ft of plug, a 50 ft of sub-surface below the plug, a 50 ft of over burden above the plug, casing, annular cement and formation. Of the 50 ft of over burden, the top 10 ft was renamed as modified over burden for all the materials. The idea behind using this modified over burden concept is explained below for the chosen example well. In the modified overburden, all materials have the modified densities as below:

$${{ρ}_{modified overburden}}^{cement} = \frac{\begin{matrix}TOC \times {ρ}_{mud} + ( Top of modified overburden - \\ TOC ) \times {ρ}_{cement}\end{matrix}}{Length of modified overburden}$$

$${{ρ}_{modified overburden}}^{plug} = \frac{\begin{matrix}TOM \times {ρ}_{mud} + ( Top of modified overburden - \\ TOS ) \times {ρ}_{spacer}\end{matrix}}{Length of modified overburden}$$

$${{ρ}_{modified overburden}}^{casing} = \frac{Top of modified overburden \times {ρ}_{casing}}{Length of modified overburden}$$

$${{ρ}_{modified overburden}}^{formation} = \frac{Top of modified overburden \times {ρ}_{formation}}{Length of modified overburden}$$

It can be seen that the densities were calculated in such a way that the stresses below the modified overburden are the same as those exerted by the entire wellbore above. During the analysis, it was appropriate to ignore the stresses generated in this modified overburden. The radial extent of the formation was selected to be large enough such that the near wellbore variation of stresses did not alter the in-situ stress state at the radially farthest distance in the formation. In the current example, the farthest radial extent of formation was 50 times the wellbore radius.

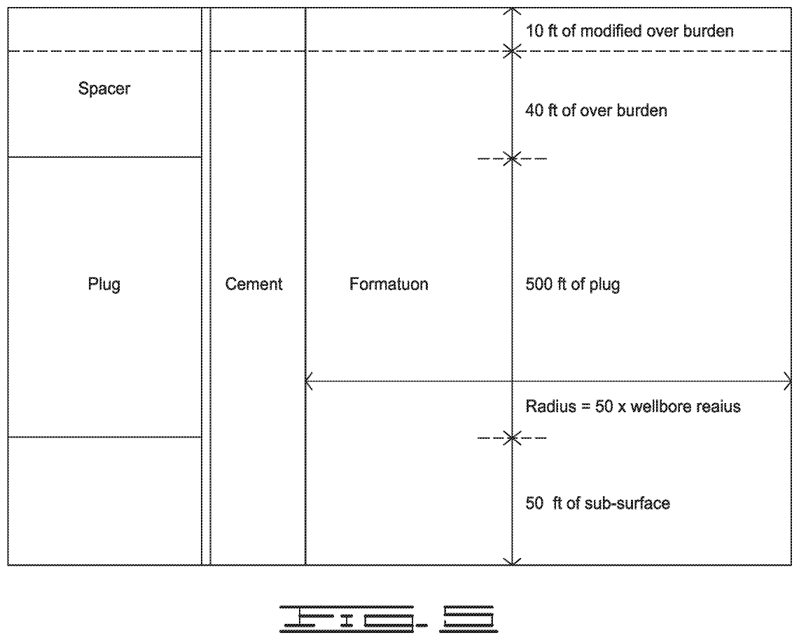

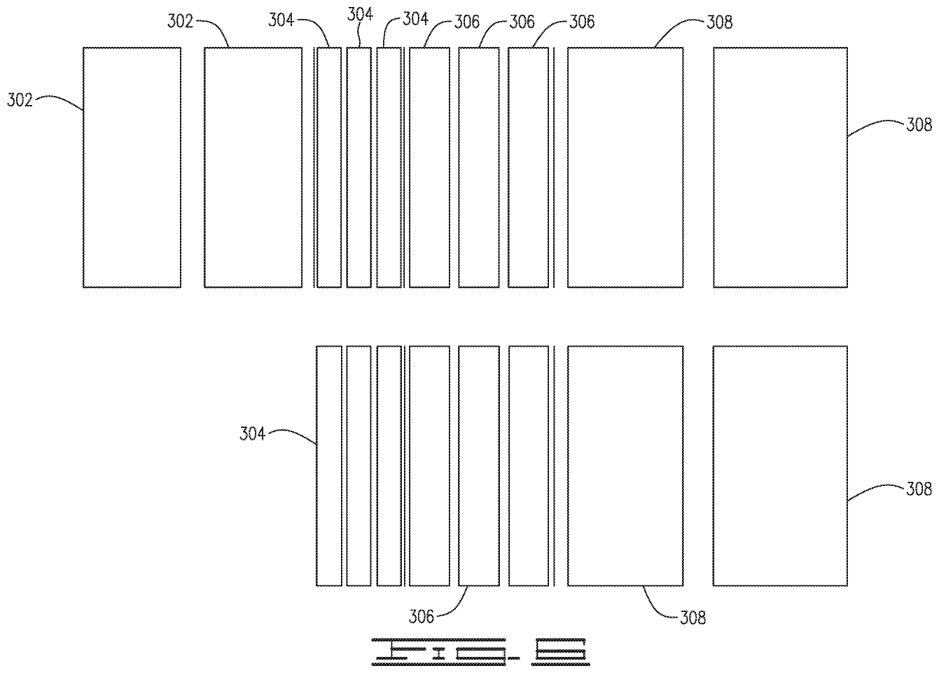

FIG. 5 illustrates a schematic of the geometric model generated for the analysis. Finite element analysis typically includes the use of mesh generation techniques for dividing a complex problem into small elements. Mesh generation is the practice of generating a polygonal or polyhedral mesh that approximates a geometric model. FIG. 6 shows a zoomed mesh view near the bottom right corner of the plug for the geometric model of the current example. FIG. 6 shows two of the many axi-symmetric elements of the plug 302, three axi-symmetric elements of the casing 304, and three axi-symmetric elements of the annular cement 306 and two of the many axi-symmetric elements of the formation 308. The top portion of FIG. 6 represents the mesh at the bottom of the plug and the bottom represents the mesh just under the plug.

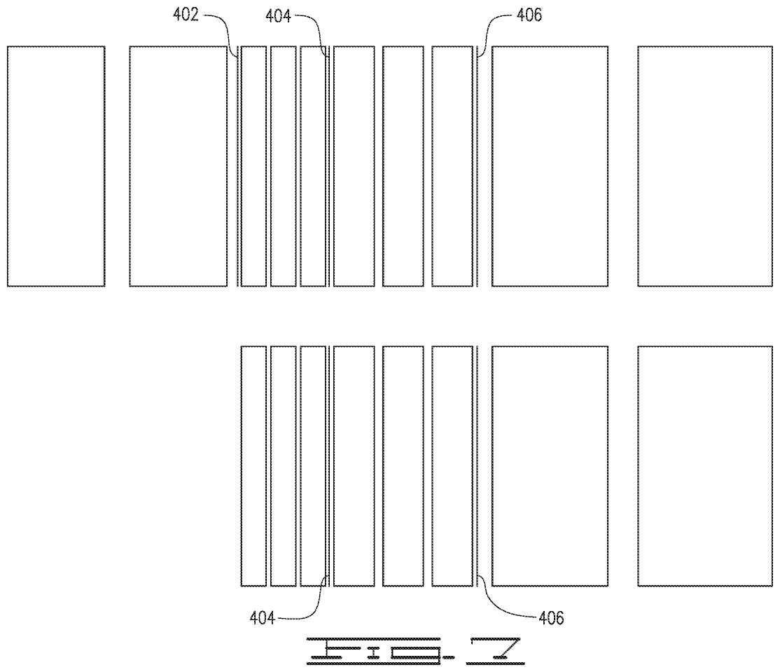

For the same meshed geometry shown in FIG. 6, FIG. 7 shows the interface elements. There will be three interfaces. The first interface 402 is between plug and casing. The second interface 404 is between casing and annular cement. The third interface 406 is between annular cement and formation.

The mesh size for each material in both radial and axial direction generally was selected in such a way that the computation would be completed in a reasonable time. The present example has 120,800 axi-symmetric elements and 13,600 interface elements connected using 399,256 nodes. The analysis time was about 30 minutes for this size of the model.

Next, thermal and structural loads were applied to the geometric model relating to the well and plug, and boundary conditions were defined to constrain the geometric model.

The load stages can be classified into three parts: the first part consists of well-construction load stages; the second part consists of well-operation load stages; and the third part consists of plug-operation load stages. A summary of structural loads and boundary conditions are shown in Tables 1-3, and a summary of thermal loads are shown in Table 4. In practice, one has to make sure that the sequence of loads actually impacting the well and plug in question are simulated.

TABLE 1
Well Construction

| | Structural Load Type and Surface/Edge on | |
|---|---|---|
| Load Stage Name | which it was Applied | Constraints/Boundary Conditions |
| Drilling | (i) Drilling mud hydrostatic on borehole wall | Bottom of wellbore supported and |
| | (ii) Annular pressure on borehole wall | Formation outer edge constrained |
| Run Casing | Displacement fluid pressure on casing inner | Bottom of casing supported and |
| | edge and | Top of casing constrained in radial |
| | Annular pressure on Casing outer edge and | direction |
| | Casing Axial Stress based on buoyancy and | |
| | hook load | |
| Cementing | Annular pressure on cement inner and outer | Bottom of cement supported and |
| | edge | Top of cement constrained in radial |
| | | direction |
| WoC | Displacement fluid pressure on casing inner | Bottom of wellbore + cement + casing |
| | edge and | supported and |
| | Formation in-situ pore pressure on cement outer | Formation outer edge constrained |
| | edge and | |
| | Casing axial stress based on buoyance and hook | |
| | load | |
| Pressure Test | Testing pressure on casing inner edge and | Bottom of wellbore + cement + casing |
| | In-situ formation pore pressure on cement outer | supported and |
| | edge and | Formation outer edge constrained |
| | Casing axial stress based on buoyance and hook | |
| | load | |

TABLE 2
Well Operation

| | Structural Load Type and Surface/Edge on | |
|---|---|---|
| Load Stage Name | which it was Applied | Constraints/Boundary Conditions |
| Production | Production fluid pressure on casing inner edge | Bottom of wellbore + cement + casing |
| | and | supported and |
| | Depleting formation pore pressure on cement | Formation outer edge constrained |
| | outer edge and | |
| | Casing axial stress based on buoyance and hook | |
| | load | |
| Preparing Wellbore for | Plug hydrostatic pressure on casing inner edge | Bottom of wellbore + cement + casing |
| WoP | and | supported and |
| | Depleting formation pore pressure on cement | Formation outer edge constrained |
| | outer edge and | |
| | Casing axial stress based on buoyance and hook | |
| | load | |

TABLE 3
Plug Operation

| | Structural Load Type and Surface/Edge on | |
|---|---|---|
| Load Stage Name | which it was Applied | Constraints/Boundary Conditions |
| Plug Placement | Hydrostatic of fluid above top plug acting on | Bottom of plug supported and |
| | plug top and | Top of plug constrained in radial |
| | Depleted formation pore pressure on plug | direction |
| | bottom and | |
| | Plug hydrostatic pressure on plug outer edge | |
| WoP | Plug hydrostatic pressure on casing inner edge | Bottom of wellbore + cement + casing |
| | and | supported and |
| | Depleted formation pore pressure on cement | Formation outer edge constrained and |
| | outer edge and | Symmetry boundary condition at the |
| | Casing axial stress based on buoyance and hook | radially middle location of plug |
| | load and | |
| | Hydrostatic of fluid above top of plug action on | |
| | plug top and | |
| | Depleted formation pore pressure on plug | |
| | bottom | |
| Plug Life | Plug hydrostatic pressure on casing inner edge | Bottom of wellbore + cement + casing |
| | and | supported and |
| | Casing axial stress based on buoyance and hook | Formation outer edge constrained and |
| | load and | Symmetry boundary conditions at the |
| | Hydrostatic of fluid above top of plug acting on | radially middle location of plug |
| | plug top and | |
| | Time varying formation pore pressure on plug | |
| | bottom | |

TABLE 4

| Classification | Load Stage | |
|---|---|---|
| of Load Stage | Name | Thermal Load Type |
| Well | Drilling | Circulating temperature on wellbore |
| Construction | | wall and |
| | | In-situ temperature on formation outer |
| | | edge |
| | Run Casing | Circulating temperature on casing |
| | Cementing | Circulating temperature on cement |
| | WoC | Circulating Temperature on casing |
| | | inner edge and |
| | | In-situ temperature on formation outer |
| | | edge |
| | Pressure Test | Circulating temperature on casing |
| | | inner edge and |
| | | In-situ temperature on formation outer |
| | | edge |
| Well | Production | Producing fluid temperature on casing |
| Operation | | inner edge and |
| | | In-situ temperature on formation outer |
| | | edge |
| | Preparing | Circulating temperature on casing |
| | wellbore for | inner edge and |
| | WoP | In-situ temperature on formation outer |
| | | edge |
| Plug | Plug Placement | Circulating temperature on plug |
| Operation | WoP | Circulating temperature on casing |
| | | inner edge and at radially middle |
| | | location of plug and |
| | | In-situ temperature on formation outer |
| | | edge |
| | Plug Life | Circulating temperature on casing |
| | | inner edge and at radially middle |
| | | location of plug and |
| | | In-situ temperature on formation outer |
| | | edge |

To ensure that the model inherits the correct stress history, these structural and thermal loads were exerted in the specified sequence.

The details of material properties used in the example analysis are shown in Table 5.

TABLE 5

| | | | | | Volumetric | | |
|---|---|---|---|---|---|---|---|
| | Young's | | Thermal | Thermal | Specific | | Friction |
| | Modulus | Poisson's | Expansion | Conductivity | Heat | Cohesion | Angle |
| Material | (Mpsi) | Ratio | (1/C) | (W/m-K) | (J/m³K | (psi) | (degrees) |
| Plug | 0.97 | 0.22 | 1.43E−05 | 0.852 | 4.00E+06 | 642 | 4.6 |
| Casing | 30.50 | 0.28 | 3.72E−06 | 46.71 | 4.00E+06 | | |
| Cement | 1.70 | 0.22 | 5.79E−06 | 0.8375 | 4.00E+06 | | |
| Formation | 0.71 | 0.33 | 4.20E−05 | 6 | 1.97E+06 | | |

Results

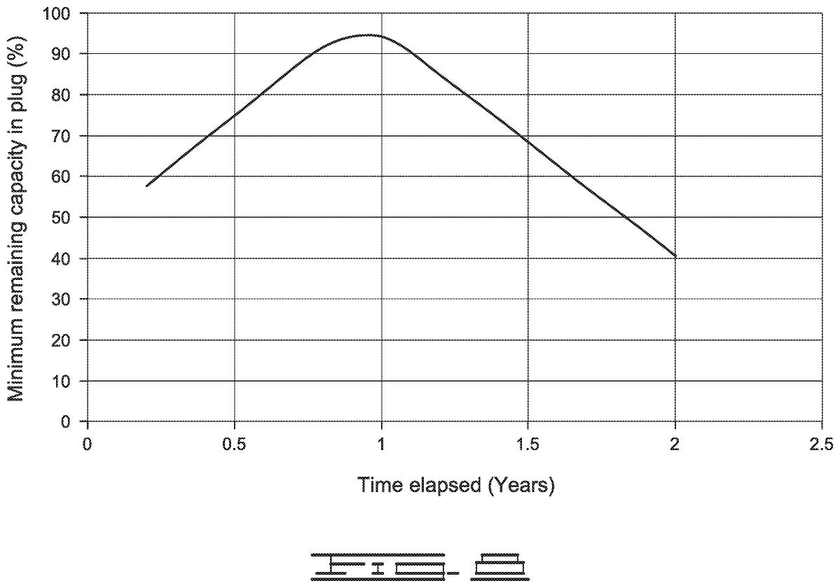

A finite element analysis was performed based on the above geometric model, conditions and load to analyze the stresses and remaining capacities of plug during its life. Using the finite element analysis, a two-year duration of plug life was analyzed in 10 uniform time steps. The results of the analysis are illustrated by FIG. 8, which illustrates the minimum remaining capacities in shear failure mode as a function of time. Remaining capacities in other modes of failure like tension and debonding can also be evaluated if those types of failure are likely.

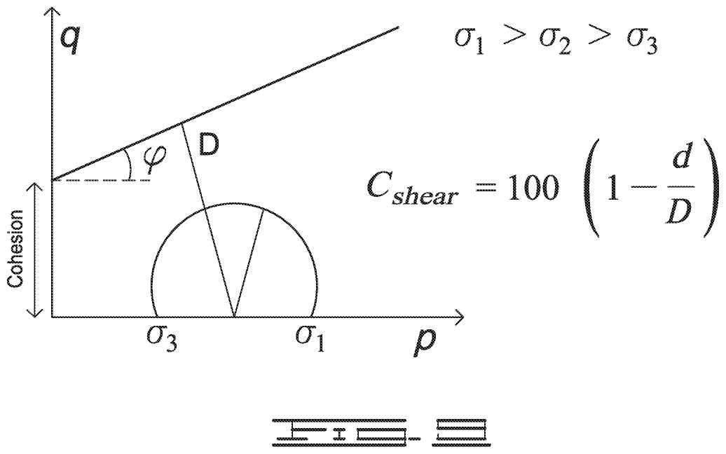

Remaining capacity can be assumed as a measure of stress on a material normalized with its strength. Using this measure, one can understand the material's distance to failure and also can compare two different materials with widely different strengths. A pictorial representation of % remaining capacity (C-shear) is shown in FIG. 9, which is a pictorial description of shear remaining capacity on a 2D Mohr-Coulomb plot.

In FIG. 9, σ1, σ2 and σ3 are three principal stresses in a material that is subjected to load. The Mohr circle defines all the combinations of stress states existing in the material in the σ1-σ3 plane. The slant line is the Coulomb line with its intercept as Cohesion and slope as friction angle (φ) of the material.

The above disclosure is exemplified by a computer-implemented method of selecting well plugs. An initial step of the method comprises defining initial physical and material properties for a geomechanical system. The geomechanical system includes a well, a plug and a well location for the plug. The well typically includes a wellbore casing and the surrounding geophysical structure; however, in some applications the well can include an uncased wellbore and the surrounding geophysical structure.

After the initial step, a geometric model based on the initial physical and material properties is generated. Generally in the method, thermal and structural loads are applied to the geometric model relating to the plug, and boundary conditions are applied to constrain the geometric model. Typically, the application of thermal and structural loads is based on well construction data, well operation data and plug operation data. However, in some embodiments where the construction and well operation data have minimal effect, the application can be of only the plug operation data.

Generally after the above steps, a numerical analysis of the geometric model is created to determine dependability of the plug. The numerical analysis determines one or more properties for elements of the geometric model based on loads experienced by the geomechanical system. The properties can include at least one of stress or deformation for elements. The elements represent portions of the geomechanical system. In some embodiments, the numerical analysis is only for a single time; however, more typically, the numerical analysis is created for a plurality of times such that the dependability determined by the numerical analysis is based on the properties for the elements as a function of time for the loads experienced by the geomechanical system.

In some embodiments, the method concludes with an analysis of the dependability of the plug resulting from the above steps. However, generally the dependability of plugs for application in a well can be better analyzed by comparing different well locations or different plug formulations. Thus, often the method will include repeating steps (a) through (c) for one or more additional geomechanical systems, where each of the additional geomechanical systems is different from other geomechanical systems used in steps (a) through (c). Typically, the difference of the additional geomechanical systems includes changing at least one initial physical or material property of the plug or changing the well location for the plug. After obtaining the dependability for various well locations and/or plug formulations, the dependability determined for each geomechanical system are compared with each other. In some embodiments, the comparing the dependability includes determining remaining capacity for the plug of each geomechanical system at the end of a predetermined period of time. Also, comparing the dependability can include determining and comparing the deformation of each plug for the geomechanical systems, and/or can include determining and comparing the stress of each plug for the geomechanical systems against strength of the plug.

After the above steps, a plug and well location for the plug is selected to use in the well. In some embodiments, this will be selecting one of the plug compositions which was used in the above steps. In other embodiments, the above steps will indicate the appropriate properties for the plug, a lab technician or scientist designs a plug composition that will meet those properties and can optionally test the plug composition to confirm if the analysis predicted properties are obtained. Subsequently, a person can then use the resulting recipe for the plug composition in performing a plug job.

In the above method, the geometric model generated can be a three-dimensional model; however, typically it will be a two-dimensional axi-symmetric model of the geomechanical system. In some cases where symmetry allows, the model can be a two-dimensional model of the geomechanical system.

In some embodiments, the geometric model is generated for the entire well. More typically, generating the geometric model is restricted to a portion of the well, which is less than the entire length of the well but includes a plug portion of the well containing the plug, an overburden portion to the plug portion and a subsurface portion to the plug portion.

Other embodiments are directed to a system for selecting well plugs, the system comprises a main memory and at least one processor. The main memory is configured to store computer readable code for an application module. The processor is coupled to the main memory. The processor executes the computer readable code in the main memory to cause the application module to perform operational steps of one of the methods described above.

Therefore, the present compositions and methods are well adapted to attain the ends and advantages mentioned, as well as those that are inherent therein. The particular examples disclosed above are illustrative only, as the present treatment additives and methods may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered or modified, and all such variations are considered within the scope and spirit of the present treatment additives and methods. While compositions and methods are described in terms of “comprising,” “containing,” “having,” or “including” various components or steps, the compositions and methods can also, in some examples, “consist essentially of” or “consist of” the various components and steps. Whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee.

1. A computer-implemented method of selecting well plugs, the method comprising:
(a) defining initial physical and material properties for a geomechanical system comprising a well, a plug and a well location for the plug, wherein the well comprises a wellbore casing and the surrounding geophysical structure;
(b) generating a geometric model based on the initial physical and material properties;
(c) creating a numerical analysis of the geometric model to determine dependability of the plug, wherein the numerical analysis determines one or more properties for elements of the geometric model based on loads experienced by the geomechanical system, and wherein the properties include at least one of stress or deformation for elements, the elements representing portions of the geomechanical system, and the numerical analysis is created fOr a plurality of times such that the dependability determined by the numerical analysis is based on the properties for the elements as a function of time for the loads experienced by the geomechanical system;
(d) repeating steps (a) through (c) for one or more additional geomechanical systems, wherein each of the additional geomechanical systems is different from other geomechanical systems used in steps (a) through (c), and the difference of the additional geomechanical systems includes changing at least one initial physical or material property of the plug or changing the well location for the plug;
(e) comparing the dependability determined for each geomechanical system; and
(f) selecting a plug and well location for the plug to use in the well based on the comparison in step (e).

2. The method of claim 1, wherein step (b) of generating the geometric model is performed so as to generate a two-dimensional axi-symmetric model of the geomechanical system.

3. The method of claim 1, wherein step (e) of comparing the dependability includes determining remaining capacity for the plug of each geomechanical system at the end of a predetermined period of time.

4. The method of claim 1, wherein step (e) of comparing the dependability includes determining and comparing the deformation of each plug for the geomechanical systems.

5. The method of claim 1, wherein step (e) of comparing the dependability includes determining and comparing the stress of each plug for the geomechanical systems against strength of the plug.

6. The method of claim 1, wherein the step (b) of generating the geometric model is restricted to a portion of the well, which is less than the entire length of the well but includes a plug portion of the well containing the plug, an overburden portion to the plug portion and a subsurface portion to the plug portion.

7. The method of claim 1, wherein prior to step (c), the method further comprises the steps of:
applying thermal and structural loads to the geometric model relating to the plug; and
defining boundary conditions to constrain the geometric model.

8. The method of claim 7, wherein the step of applying thermal and structural loads is based cm well construction data, well operation data and plug operation data.

9. The method of claim 8, wherein the step (b) of generating the geometric model is restricted to a portion of the well, which is less than the entire length of the well but includes a plug portion of the well containing the plug, an overburden portion to the plug portion and a subsurface portion to the plug portion.

10. The method of claim 1, wherein step (e) of comparing dependability includes determining the remaining capacity for the plug of each geomechanical system at the end of a predetermined period of time.

11. A system for selection well plugs, the system comprising:
a main memory configured to store computer readable code for an application module;
at least one processor coupled to the main memory, said at least one processor executing the computer readable code in the main memory to cause the application module to perform operational steps of:
(a) defining initial physical and material properties for a geomechanical system comprising a well, a plug and a well location for the plug, wherein the well comprises a wellbore casing and the surrounding geophysical structure;
(b) generating a geometric model based on the initial physical and material properties;
(e) creating a numerical analysis of the geometric model to determine dependability of the plug, wherein the numerical analysis determines one or more properties for elements of the geometric model based on loads experienced by the geomechanical system, and wherein the properties include at least one of stress or deformation for elements, the elements representing portions of the geomechanical system, and the numerical analysis is created for a plurality of times such that the dependability determined by the numerical analysis is based on the properties for the elements as a function of time for the loads experienced by the geomechanical system;
(d) repeating steps (a) through (c) for one or more additional geomechanical systems, wherein each of the additional geomechanical systems is different from other geomechanical systems used in steps (a) through (c), and the difference of the additional geomechanical systems includes changing at least one initial physical or material property of the plug or changing the well location for the plug;
(e) comparing the dependability determined for each geomechanical system; and
(f) selecting a plug and well location for the plug to use in the well based on the comparison in step (e).

12. The system of claim 11, wherein the generating the geometric model is performed so as to generate a two-dimensional axi-symmetric model of the geomechanical system.

13. The system of claim 11, wherein comparing dependability includes determining remaining capacity for the plug of each geomechanical system at the end of a predetermined period of time.

14. The system of claim 11, wherein comparing the dependability includes determining and comparing the deformation of each plug for the geomechanical systems.

15. The system of claim 11, wherein the generating the geometric model is restricted to a portion of the well, which is less than the entire length of the well but includes a plug portion of the well containing the plug, an overburden portion to the plug portion and a subsurface portion to the plug portico.

16. The system of claim 11, wherein the operational steps include, prior to creatine a finite element analysis, the steps of:
applying thermal and structural loads to the geometric model; and
defining boundary conditions to constrain the geometric model.

17. The system of claim 16, wherein the applying thermal and structural loads is based on well construction data, well operation data and plug operation data.

18. The system of claim 17, wherein the generating the geometric model is performed so as to generate a two-dimensional axi-symmetric model of the geomechanical system.

19. The system of claim 18, wherein the generating a geometric model is restricted to a portion of the well, which is less than the entire length of the well but includes a plug portion of the well containing the plug, an overburden portion to the plug portion and a subsurface portion to the plug portion.

20. The system of claim 19, wherein the comparing dependability includes determining the remaining capacity for the plug of each geomechanical system at the end of a predetermined period of time.
